(19) United States
(12) Patent Application Publication
(10) Pub. No.: US 2011/0047055 A1
(43) Pub. Date: Feb. 24, 2011

(54) Dynamic Computer-Based Information Management System

(76) Inventor: Maximillian Funk, Rancho Mirage, CA (US)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 12/546,065

(22) Filed: Aug. 24, 2009

(51) Int. Cl. G06Q 40/00; G06Q 30/00

(52) U.S. Cl. 705/34; 705/36 R; 705/37

(57) ABSTRACT

The invention is directed to a computer readable medium having computer readable instructions adapted and configured to instruct a computer to perform a method comprising: receiving values from any information transmission device; recording a near-immediate transition of any number of values between any number of system elements, using a float of electronically produced schedule keepers of value quantifying a change in any variables with respect to users in an application; and at least one of correcting and transmitting information to assist with delivering useful information to achieve a desired outcome. In some aspects, the variable is currency. In still other configurations, the application is a financial application. Values can be selected from the group consisting of single or multivariable, as desired or preferred. Moreover, the system elements are identified by contextual information disclosed by a user. Furthermore, the method can also comprise the step of: reducing a payment to a vendor by an amount of one or more of a fee for a transaction and a tax. In some cases, the method can further comprising: deducting an additional fee by an amount of one or more of a fee for a transaction and a tax.

### BACKGROUND OF THE INVENTION

Over the past ten years the Internet has been increasingly accepted as a distribution channel for consumers and businesses. A significant catalyst to the digital industry has been the proliferation of mobile digital players, ranging from iPods® to PocketPCs® and Palms to smart mobile devices (SMDs). Apple alone sold nearly 39 million iPods worldwide in 2006, reflecting annual growth of nearly 22%. On the horizon are smart phones or SMDs, which combine the function of PDAs such as on-board memory, and the ability to play digital media with cellular phone services. It is anticipated that by the end of 2009, SMDs will have become the device of choice for digital media content.

What is needed therefore is a computer implemented system that enables efficient and dynamic data analysis and modeling.

### SUMMARY OF THE INVENTION

An aspect of the invention is directed to a computer readable medium having computer readable instructions adapted and configured to instruct a computer to perform a method comprising: receiving values from any information transmission device; recording a near-immediate transition of any number of values between any number of system elements, using a float of electronically produced schedule keepers of value quantifying a change in any variables among system elements within an application; and at least one of correcting and transmitting information to assist with delivering useful information to achieve a desired outcome. In some aspects, the variable is currency, or any technology used for quantifying the transition of financial values. Values can be selected from the group consisting of single or multivariable, as desired or preferred. Moreover, the system elements are identified by contextual information disclosed by a user in the financial application, or a system engineer in other applications. Furthermore, the method can also comprise the step of: reducing a payment to a commercial vendor by an amount of one or more of a fee for a transaction for the service provide and a tax payable to a governmental entity. In some cases, the method can further comprising: deducting an additional fee by an amount of one or more of a fee for a transaction and a tax.

Another aspect of the invention is directed to a computer readable medium having computer readable instructions adapted and configured to instruct a computer to perform a method comprising: receiving values on a first electronic device from any second electronic device further comprising an information transmission device; recording a near-immediate transition on the first electronic device of any number of values between any number of system elements, using a float of electronically produced schedule keepers on the first electronic device of value quantifying a change in any variables among system elements within an application; and at least one of correcting and transmitting information on the first electronic device to assist with delivering useful information to achieve a desired outcome. In some aspects, the variable is currency, or any technology used for quantifying the transition of financial values. Values can be selected from the group consisting of single or multivariable, as desired or preferred. Moreover, the system elements are identified by contextual information disclosed by a user in the financial application, or a system engineer in other applications. Furthermore, the method can also comprise the step of: reducing a payment to a commercial vendor by an amount of one or more of a fee for a transaction for the service provide and a tax payable to a governmental entity. In some cases, the method can further comprising: deducting an additional fee by an amount of one or more of a fee for a transaction and a tax.

In another aspect of the invention, the invention is directed to a system adapted and configured for producers and consumers to conduct transactions on a computer implemented system using a digital currency comprising: a smart electronic digital currency device adapted and configured to maintain owner identifiable information across time; a communicator adapted and configured to enable a buyer and seller within a system to access one or more of business and financial information; an input device adapted and configured for inputting an amount of a digital currency transaction; a transmitter adapted and configured for sending digital currency transaction information pertaining to a trade via a common application that includes market participant information and a transaction amount in a digital currency; a communications network adapted and configured for conveying the digital currency transaction information; and a server arranged with a receiver and adapted and configured for receiving the digital currency transaction information and for maintaining current digital currency account information on behalf of all system participants. The server can be arranged to reduce a payment to a seller by an amount of a market-making service fee, for example. Additionally, a digital currency transaction engine can be provided for keeping an accounting of a digital currency balance owed to any system participant. In other embodiments, a transaction information storage device can be provided that is adapted and configured for storing consumer digital currency credit account information and transaction information. A customer program data storage device can also be provided for storing customer program data for use in one or more customer programs directed to at least one of the system or market participants. In some aspects a communications network is provided that comprises at least one of a wired network and a wireless network.

Yet another aspect of the invention is directed to a method for a consumer to make transactions in a digital currency at a predetermined exchange rate, comprising: enabling a consumer to prepay an issuer for a selected quantity of a digital currency at a exchange rate determined by the issuer; issuing to the consumer a digital currency that identifies the consumer and indicates an amount of the digital currency owed by the issuer to the consumer for use in digital currency transactions made using the digital currency; enabling the consumer to conduct at least one transaction with a seller in an amount of the digital currency not to exceed the selected amount; paying a digital currency in the amount of the transaction to the seller; and reducing a quantity of the digital currency owed to the consumer by the amount of the transaction. As will be appreciated by those skilled in the art, the step of issuing can be performed anonymously. Moreover, the digital currency transaction can be, for example, a purchase or a cash withdrawal. Additionally, the sellers can be charged a transaction fee for enabling a more efficient transaction. In some aspects, the method further comprises calculating the digital currency exchange rate based on a spot exchange rate at the time of the consumer pre-paying the issuer. Additionally, information pertaining to the quantity of digital currency owed to the consumer can be stored within the digital currency account. Information pertaining to the quantity of digital currency owed to the consumer can also be stored on a server.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing a representative example of a logic device through which dynamic data analysis and modeling can be achieved;

FIG. 1B is a block diagram of an exemplary computing environment through which dynamic data analysis and modeling can be achieved;

FIG. 1C is an illustrative architectural diagram showing some structure that can be employed by devices through which dynamic data analysis and modeling is achieved;

FIG. 2 is an exemplary diagram of a server in an implementation suitable for use in a system where dynamic data analysis and modeling is achieved;

FIG. 3 is an exemplary diagram of a master system in an implementation suitable for use in a system where dynamic analysis and modeling is achieved;

FIG. 4 is a block diagram showing the cooperation of exemplary components of a system suitable for use in a system where dynamic data analysis and modeling is achieved;

FIGS. 5A and 5B show conversion functions which can be implemented as a software module or via other means; FIG. 5C shows a diagram wherein multiple participants communicate to achieve dynamic data analysis and modeling.

FIG. 6 is a flow diagram showing the cooperation of exemplary participants of an illustrative implementation of a foreign currency transaction platform;

FIG. 7 is a block diagram showing the cooperation of exemplary components of an illustrative implementation of a foreign currency transaction platform;

FIG. 8 is a block diagram of the components for the present system and system flow;

FIG. 9 illustrates a mock-up of a web page illustrating currency as a flat digital currency;

FIGS. 10A-B illustrate computing devices which displays a transaction

FIG. 11 illustrates a table with time and date stamp and user ID for currency;

FIG. 12 illustrates a single user or assembly digital credits;

FIG. 13 illustrates a table calculating revenue generated system wide per unit of time;

FIG. 14 illustrates a micro level and transition of a single schedule keeper with digital credits;

FIG. 15 illustrates a macro level of whole transactions in a system containing 7 transactions; and

FIG. 16 illustrates a micro level and transition of single schedule keepers and unitary GPS readings.

### DETAILED DESCRIPTION OF THE INVENTION

Devices, systems and methods are provided which provide a dynamic data model. This dynamic model essentially provides for system-clocking of data and has a wide variety of applications which will become apparent to those skilled in the art upon review of this disclosure. In the broadest sense a databank is provided which includes a single or multi-variable based schedule keeper of value(s) that provide information about their flow and velocity within a system of elements at any given interval of time. The databank is enabled with the use of an electronic device which calculates a value of the data according to the general equation:

Where:
w=number of schedule keeping entries receiving value per system participant (where x=y)
u=total number of system participants
Mx!=the sum total of the speed of values flowing through the system at an interval maintained by the system

System-wide trafficking of information with respect to time has a wide variety of uses including, but not limited to, for example: financial value traded between two traders in a financial market; reduction in tax revenue loss on behalf of small to large public service entities; improving the public's ability to gauge the usefulness of implementing fiscal policy; modeling physical phenomena (historical, present or hypothetical), such as inventory management, navigation, weather, demand for electricity, communication bandwidth; and laboratory research modeling, such as pharmaceutical, biological, or medical technologies.

A basic example using parameters defined within a two-variable system is:

$$M x ! ≡ {\sum }_{i = 1}^{u} {w}_{i}$$

where,
t=unit of time (e.g., second)
xᵢ=value (number or scalar) received by any schedule-keeping record at a particular time, e.g., value assessed by trackers in a market (scalar/layer) with x₁−x₂=0, the “quantified difference” between how two system participants should reconcile value at any particular time, or x₁=x₂.

Mx! calculates the speed of all values flowing through an electronic system, such as a computer, at any designated interval of time and the transformation of the value being generated by the trade of each individual digital credit. In this example, the values being generated y the trade of each digital credit is “1”, and “0” for all digital credits that are not being traded at the same interval. Therefore, the sum of the single digital credits being transformed by the electronic system for every interval of time equals the total revenue generated by the entire system. The total revenue generated is analogous to being able to calculate economic metrics such as the Gross National Product (GNP) at any interval of time desired.

### I. Computing Systems

The systems and methods described herein rely on a variety of computer systems or digital devices for operation. In order to fully appreciate how the system operates an understanding of suitable computing systems is useful. The systems and methods disclosed herein are enabled as a result of application via a suitable computing system.

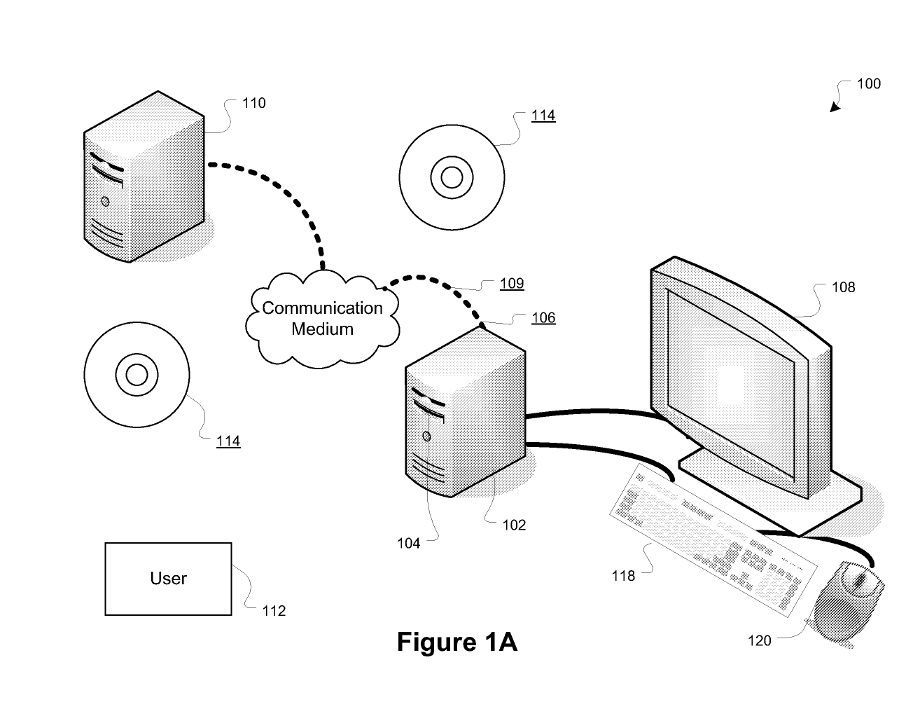

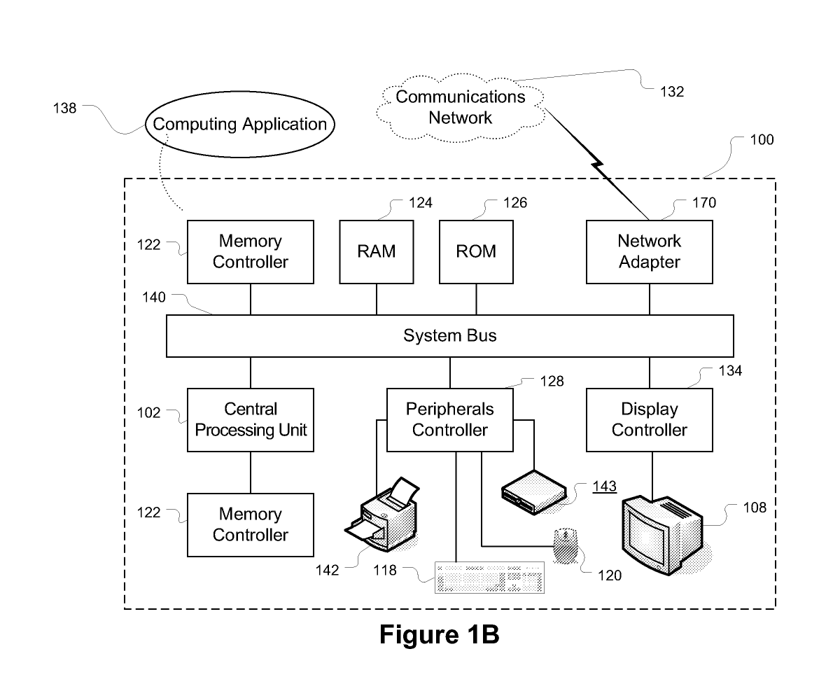

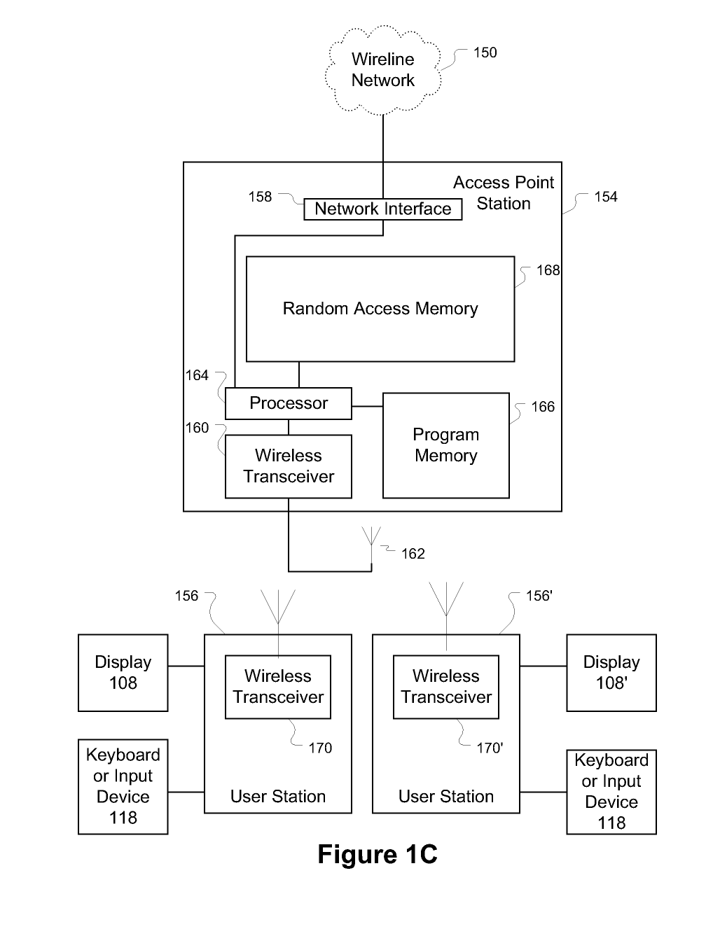

FIG. 1A is a block diagram showing a representative example logic device through which a browser can be accessed to implement the present invention. A computer system (or digital device) 100, which may be understood as a logic apparatus that can read instructions from media 114 and/or network port 106, can optionally be connected to server 110, having fixed media 116. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present invention can be transmitted over such networks or connections. The computer system can be adapted to communicate with a participant and/or a device used by a participant. The computer system can be adapted to communicate with other computers over the internet, or with computers via a server.

FIG. 1B depicts another exemplary computing system 100. The computing system 100 is capable of executing a variety of computing applications 138, including computing applications, a computing applet, a computing program, or other instructions for operating on computing system 100 to perform at least one function, operation, and/or procedure. Computing system 100 may be controlled by computer readable instructions, which may be in the form of software. The computer readable instructions can contain instructions for computing system 100 for storing and accessing the computer readable instructions themselves. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

In basic IP routing (e.g., outside mobile IP), routing mechanisms rely on the assumptions that each network node always has a constant attachment point to the Internet and that each node's IP address identifies the network link it is attached to. In this document, the terminology “node” includes a connection point, which can include a redistribution point or an end point for data transmissions, and which can recognize, process and/or forward communications to other nodes. For example, Internet routers can look at an IP address prefix or the like identifying a device's network. Then, at a network level, routers can look at a set of bits identifying a particular subnet. Then, at a subnet level, routers can look at a set of bits identifying a particular device. With typical mobile IP communications, if a user disconnects a mobile device from the Internet and tries to reconnect it at a new subnet, then the device has to be reconfigured with a new IP address, a proper netmask and a default router. Otherwise, routing protocols would not be able to deliver the packets properly.

FIG. 1C depicts components that can be employed in system configurations enabling the systems of this invention, including wireless access points to which client devices communicate. In this regard, FIG. 1C shows a wireless network 150 connected to a wireless local area network (WLAN) 152. The WLAN 152 includes an access point (AP) 154 and a number of user stations 156, 156. For example, the network 150 can include the Internet or a corporate data processing network. For example, the access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172 for communication to the access point 154. By way of example, in some embodiments an authenticator could be employed within such an access point (AP) and/or a supplicant or peer could be employed within a mobile node or user station. Desktop 108 and key board 118 or input devices can also be provided with the user status.

Iv. Media Independent Handover Services

In IEEE P802.21/D.01.09, Sep. 2006, entitled Draft IEEE Standard for Local and Metropolitan Area Networks: Media Independent Handover Services, among other things, the document specifies 802 media access-independent mechanisms that optimize handovers between 802 systems and cellular systems. The IEEE 802.21 standard defines extensible media access independent mechanisms that enable the optimization of handovers between heterogeneous 802 systems and may facilitate handovers between 802 systems and cellular systems. “The scope of the IEEE 802.21 (Media Independent Handover) standard is to develop a specification that provides link layer intelligence and other related network information to upper layers to optimize handovers between heterogeneous media. This includes links specified by 3GPP, 3GPP2 and both wired and wireless media in the IEEE 802 family of standards. Note, in this document, unless otherwise noted, “media” refers to method/mode of accessing a telecommunication system (e.g. cable, radio, satellite, etc.), as opposed to sensory aspects of communication (e.g. audio, video, etc.).” See 1.1 of I.E.E.E. P802.21/D.01.09, Sep. 2006, entitled Draft IEEE Standard for Local and Metropolitan Area Networks: Media Independent Handover Services, the entire contents of which document is incorporated herein into and as part of this patent application. Other IEEE, or other such standards on protocols can be relied on as appropriate or desirable.

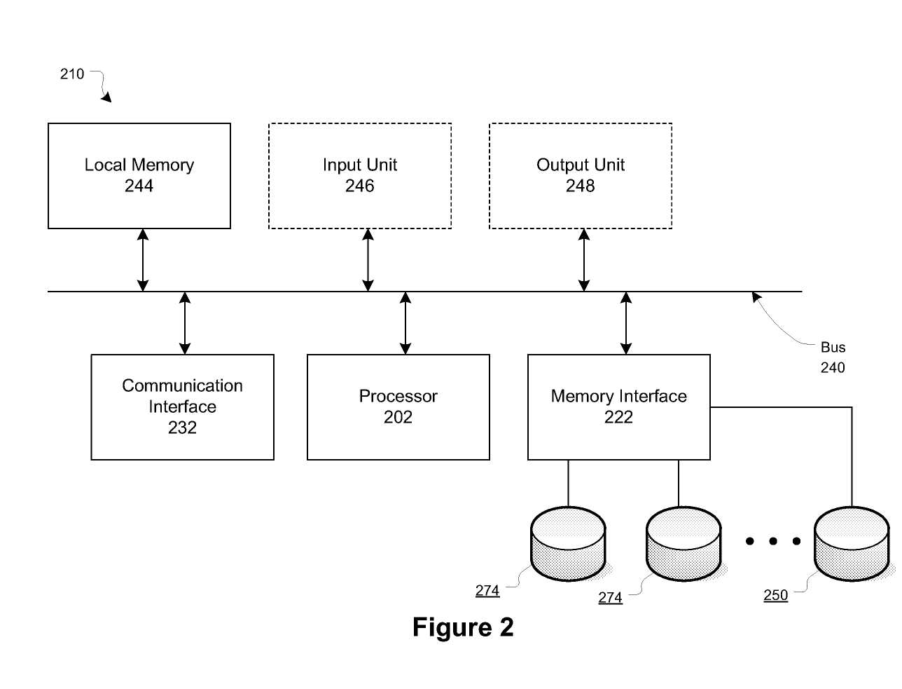

FIG. 2 is an exemplary diagram of a server 210 in an implementation consistent with the principles of the invention. Server 210 may include a bus 240, a processor 202, a local memory 244, one or more optional input units 246, one or more optional output units 248, a communication interface 232, and a memory interface 222. Bus 240 may include one or more conductors that permit communication among the components of chunk server 250.

Processor 202 may include any type of conventional processor or microprocessor that interprets and executes instructions. Local memory 244 may include a random access memory (RAM) or another type of dynamic storage device that stores information and instructions for execution by processor 202 and/or a read only memory (ROM) or another type of static storage device that stores static information and instructions for use by processor 202.

Input unit 246 may include one or more conventional mechanisms that permit an operator to input information to a server 110, such as a keyboard 118, a mouse 120 (shown in FIG. 1), a pen, voice recognition and/or biometric mechanisms, etc. Output unit 248 may include one or more conventional mechanisms that output information to the operator, such as a display 134, a printer 130 (shown in FIG. 1), a speaker, etc. Communication interface 232 may include any transceiver-like mechanism that enables chunk server 250 to communicate with other devices and/or systems. For example, communication interface 232 may include mechanisms for communicating with master and clients.

Memory interface 222 may include a memory controller 122. Memory interface 222 may connect to one or more memory devices, such as one or more local disks 274, and control the reading and writing of chunk data to/from local disks 276. Memory interface 222 may access chunk data using a chunk handle and a byte range within that chunk.

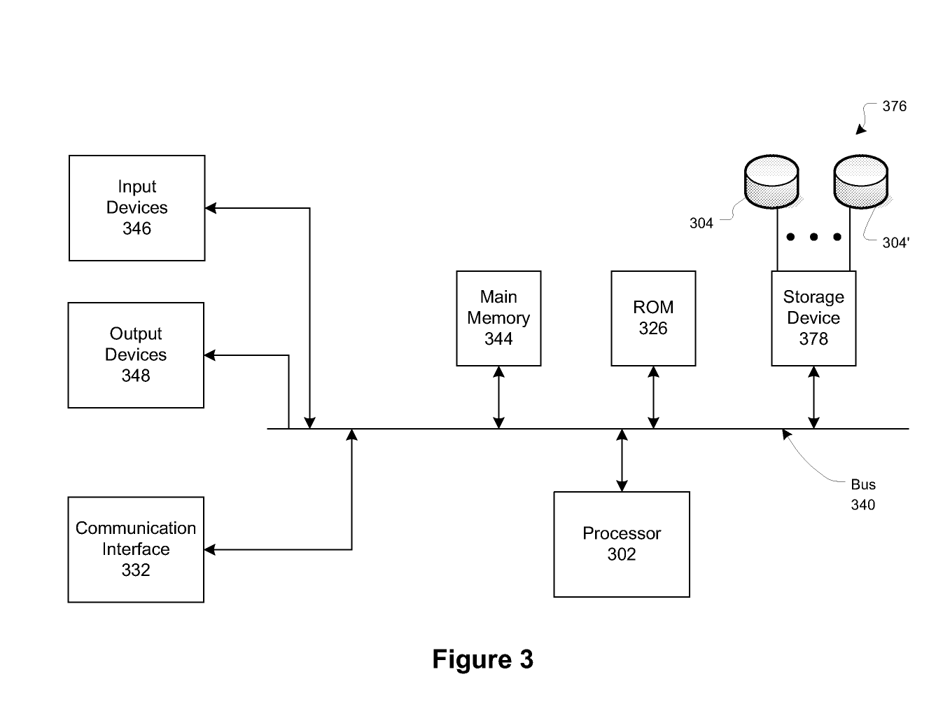

FIG. 3 is an exemplary diagram of a master system 376 suitable for use in an implementation consistent with the principles of the invention. Master system 376 may include a bus 340, a processor 302, a main memory 344, a ROM 326, a storage device 378, one or more input devices 346, one or more output devices 348, and a communication interface 332. Bus 340 may include one or more conductors that permit communication among the components of master system 374.

Processor 302 may include any type of conventional processor or microprocessor that interprets and executes instructions. Main memory 344 may include a RAM or another type of dynamic storage device that stores information and instructions for execution by processor 302. ROM 326 may include a conventional ROM device or another type of static storage device that stores static information and instructions for use by processor 302. Storage device 378 may include a magnetic and/or optical recording medium and its corresponding drive. For example, storage device 378 may include one or more local disks that provide persistent storage.

Input devices 346 may include one or more conventional mechanisms that permit an operator to input information to the master system 374, such as a keyboard 118, a mouse 120, (shown in FIG. 1) a pen, voice recognition and/or biometric mechanisms, etc. Output devices 348 may include one or more conventional mechanisms that output information to the operator, including a display 108, a printer 142 (shown in FIG. 1), a speaker, etc. Communication interface 332 may include any transceiver-like mechanism that enables master system 374 to communicate with other devices and/or systems. For example, communication interface 332 may include mechanisms for communicating with servers and clients as shown above.

Master system 376 may maintain file system metadata within one or more computer readable mediums, such as main memory 344 and/or storage device.

The computer implemented system provides a storage and delivery base which allows users to exchange services and information openly on the Internet. A user will be enabled to operate as both a consumer and producer of any and all digital content or information through one or more master system servers.

A user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

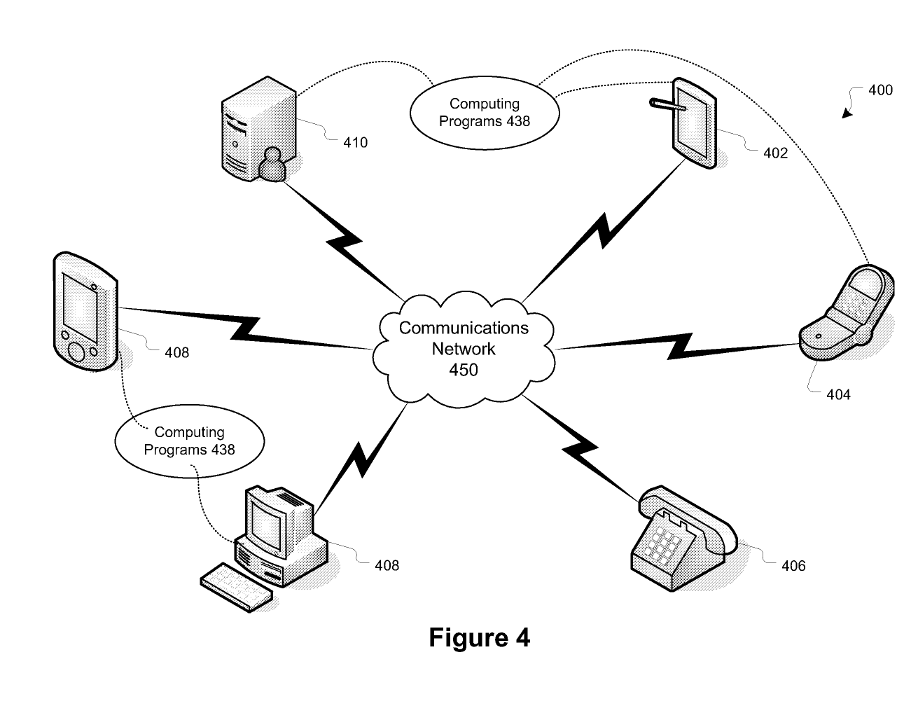

Computing system 100, described above, can be deployed as part of a computer network. In general, the above description for computing environments applies to both server computers and client computers deployed in a network environment. FIG. 4 illustrates an exemplary illustrative networked computing environment 400, with a server in communication with client computers via a communications network 450. As shown in FIG. 4, server 410 may be interconnected via a communications network 450 (which may be either of, or a combination of a fixed-wire or wireless LAN, WAN, intranet, extranet, peer-to-peer network, virtual private network, the Internet, or other communications network) with a number of client computing environments such as tablet personal computer 402, mobile telephone 404, telephone 406, personal computer 402, and personal digital assistant 408. In a network environment in which the communications network 450 is the Internet, for example, server 410 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Additionally, networked computing environment 400 can utilize various data security protocols such as secured socket layer (SSL) or pretty good privacy (PGP). Each client computing environment can be equipped with operating system 438 operable to support one or more computing applications, such as a web browser (not shown), or other graphical user interface (not shown), or a mobile desktop environment (not shown) to gain access to server computing environment 400.

In operation, a user (not shown) may interact with a computing application running on a client computing environment to obtain desired data and/or computing applications. The data and/or computing applications may be stored on server computing environment 400 and communicated to cooperating users through client computing environments over exemplary communications network 450. A participating user may request access to specific data and applications housed in whole or in part on server computing environment 400. These data may be communicated between client computing environments and server computing environments for processing and storage. Server computing environment 400 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VI. Media Independent Information Service

The Media Independent Information Service (MIIS) provides a framework and corresponding mechanisms by which an MIHF entity may discover and obtain network information existing within a geographical area to facilitate handovers. Additionally or alternatively, neighboring network information discovered and obtained by this framework and mechanisms can also be used in conjunction with user and network operator policies for optimum initial network selection and access (attachment), or network re-selection in idle mode.

MIIS primarily provides a set of information elements (IEs), the information structure and its representation, and a query/response type of mechanism for information transfer. The information can be present in some information server from which, e.g., an MIHF in the Mobile Node (MN) can access it.

Depending on the type of mobility, support for different types of information elements may be necessary for performing handovers. MIIS provides the capability for obtaining information about lower layers such as neighbor maps and other link layer parameters, as well as information about available higher layer services such as Internet connectivity.

MIIS provides a generic mechanism to allow a service provider and a mobile user to exchange information on different handover candidate access networks. The handover candidate information can include different access technologies such as IEEE 802 networks, 3GPP networks and 3GPP2 networks. The MIIS also allows this collective information to be accessed from any single network. For example, by using an IEEE 802.11 access network, it can be possible to get information not only about all other IEEE 802 based networks in a particular region but also about 3GPP and 3GPP2 networks. Similarly, using, e.g., a 3GPP2 interface, it can be possible to get access to information about all IEEE 802 and 3GPP networks in a given region. This capability allows the MN to use its currently active access network and inquire about other available access networks in a geographical region. Thus, a MN is freed from the burden of powering up each of its individual radios and establishing network connectivity for the purpose of retrieving heterogeneous network information. MIIS enables this functionality across all available access networks by providing a uniform way to retrieve heterogeneous network information in any geographical area.

### VI. MIH Services

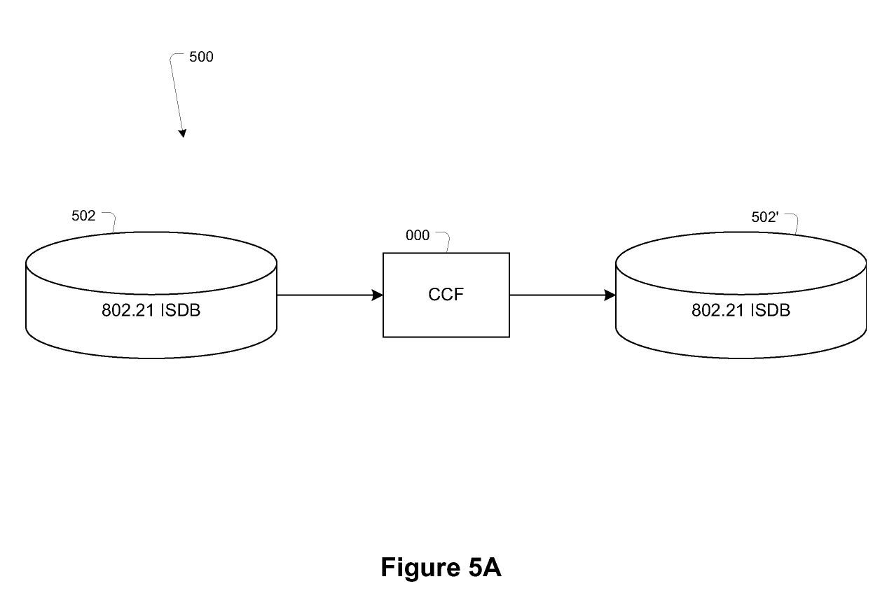

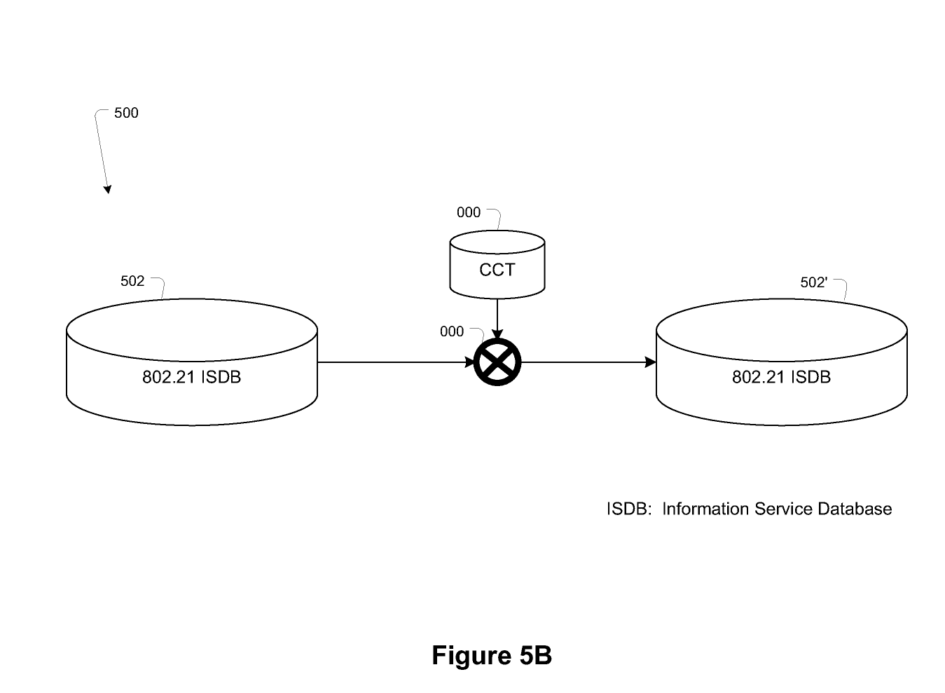

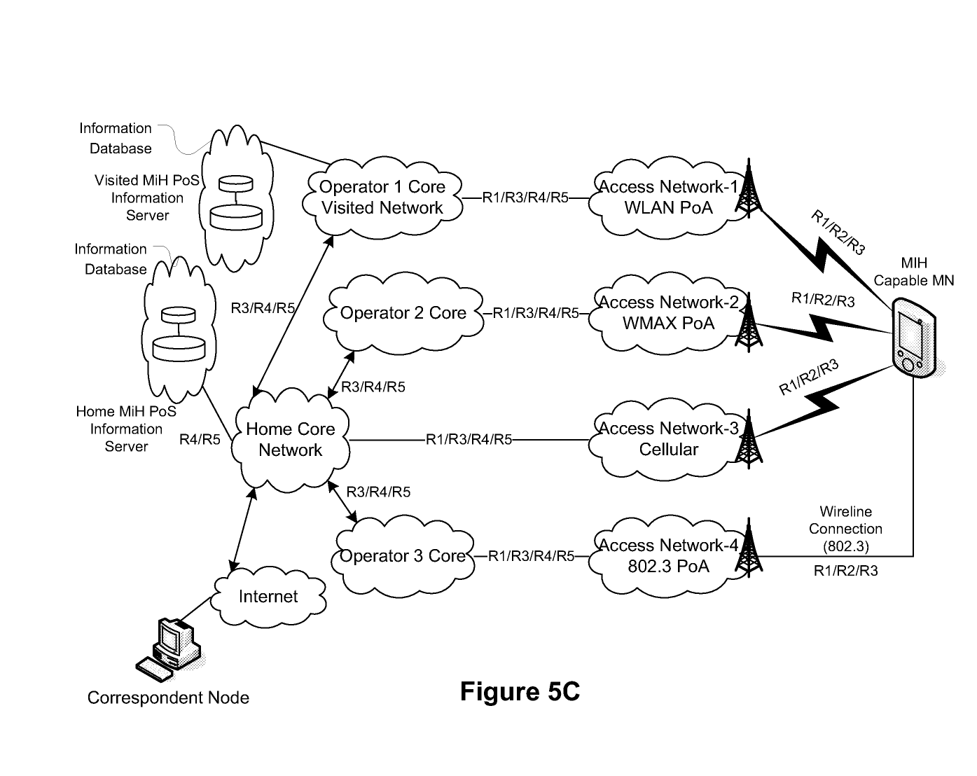

The 802.21 draft standard sets forth the following example of a network model including Media Independent Handover (MIH) services as depicted in FIGS. 5A-C illustrates the MIH reference points. An MIH-capable mobile node 502 that supports multiple wired and wireless access technologies and provides an information service database (ISDB). A serving network can either operate multiple link-layer technologies or allow its user to roam into other networks when a service level agreement (SLA) in support of inter-working has been established. The depicted model shows some illustrative access networks that are connected in, e.g., a loose, serial way to a given core network (e.g., Core Operator 1, 2, or 3). The depicted model also shows an illustrative access network that is more tightly coupled (Access Network-3). Although not shown in FIG. 5C, an access network can also connect to a core network via the Internet. Each Core Operator network (e.g., 1, 2, or 3) can represent, for example, a service provider, a corporate Intranet provider, or, e.g., just another part of the visited or home access. In this illustrative model, the provisioning provider is operating Access Network-3, which couples the terminal to the core (labeled Home Core Network) via R1. At any given point in time, the subscriber's serving network may be the home subscriber network or a visited network.

The network providers offer MIH services in their access networks (Access Network-1 to 4) in order to facilitate heterogeneous handovers into their networks. Each access technology either advertises its MIH capability or responds to MIH service discovery. Each service provider for these access networks allows access to one or more MIH Points of Service (PoS) node(s). These PoS nodes may provide some or all of the MIH services as determined during the MIH capabilities discovery. The PoS location may vary based on the operator deployment scenario and the technology-specific MIH architecture.

An MIH PoS may reside next to, or co-located with, the point of attachment (PoA) node in the access network (e.g., Access Network 1, 2, 4). Alternatively, the PoS may reside deeper inside the access or core networks (e.g., Access Network 3). As shown in FIG. 5C, the MIH entity in the MN can communicate with MIH network entities using reference points R1, R2, or R3 over any of the available access network. If the PoA in the serving access network has a co-located MIHF, the RP1 reference point terminates at the PoA which is also the PoS (MN to Access Network 1, 2, 4 of the model can all be RP1). In that case, an R3 reference point would be terminated at any non-PoA (illustrated by MN connectivity to Access Networks 1, 2, 4). MIH events may originate at both sides of an active R1 link. The MN is typically the first node to react to these events.

### VII. Access Information Service Before Authentication

With certain access networks an MN should be able to obtain IEEE 802.21 related information elements before the MN is authenticated with the PoA. These information elements may be used by the handover policy function to determine if the PoA can be selected. In order to enable the information query before authentication, individual link technologies may provide an L2 or media-specific transport or a protocol message exchange that makes this MIIS query exchange possible between the user equipment (MN) and a certain MIHF in the network. The MIHF in the MN discovers the MIH capability support from the PoA through the media-specific broadcast information containing the system capabilities. It is noted that the pre-authentication query facility is provided only for MIH information query and cannot be used for carrying other MIH protocol services except MIES and/or MICS capability discovery query using MIH_Capability_Discover embedded into L2 management frames. Additionally, any MIHF within the network may request for the set of information elements from a peer MIHF located in the same or a different network using the MIH protocol.

Allowing access of information service before authentication carries certain security risks such as denial-of-service attacks and exposure of information to unauthorized MNs. In such scenarios, the information service provider may limit the scope of information accessible to an unauthenticated MN.

After authentication and attachment to a certain PoA, the MIH protocol may be used for information retrieval by use of data frames specific to that media technology.

In any case, the MIHF should have the knowledge of whether or not a network supports this standard, and may obtain this knowledge by means of media independent or media-specific discovery mechanisms.

Viii. Information Elements

The 802.21 draft standard also sets forth that Information Service elements are classified into three groups:

1) General Information and Access Network Specific Information: These information elements give a general overview of the different networks providing coverage within an area. For example, a list of available networks and their associated operators, roaming agreements between different operators, cost of connecting to the network and network security and quality of service capabilities.

2) PoA Specific Information: These information elements provide information about different PoAs for each of the available access networks. These IEs include PoA addressing information, PoA location, data rates supported, the type of PHY and MAC layers and any channel parameters to optimize link layer connectivity. This may also include higher layer services and individual capabilities of different PoAs.

3) Other information that may be access network specific, service specific, or vendor/network specific. The 802.21 standard sets forth a list of information element containers that are used in TLV based query method. As set forth in the draft 802.21 standard, the Mobile-initiated Handover Procedure operates as follows:

a) Mobile Node is connected to the serving network via Current PoS and it has access to MIH Information Server.

b) Mobile Node queries information about neighboring networks by sending the MIH_Get_Request to Information Server. Information Server responds with MIH_Get_Information Response. This information query may be attempted as soon as Mobile Node is first attached to the network.

c) Mobile Node triggers a mobile-initiated handover by sending a MIH_MN_HO_Candidate_Query Request to Serving PoS. This request contains the information of potential candidate networks.

d) Serving PoS queries the availability of resources at the candidate networks by sending MIH_N2N_HO_Query_Resources Request to one or multiple Candidate PoSs.

e) Candidate PoSs respond with MIH_N2N_HO_Query_Resources Response and Serving PoS notifies the Mobile Node of the resulting resource availability at the candidate networks through MIH_MN_HO_Candidate_Query Response.

f) Mobile Node decides the target of the handover and commits a link switch to the target network interface.

The Network-initiated Handover Procedure according to the 802.21 standard operates as follows:

1) Serving PoS sends MIH_Get_information Request to Information Server to get neighboring network information and Information Server responds by sending MIH_Get_Information Response.

2) Serving PoS triggers a network-initiated handover by sending MIH_Net_HO_Candidate_Query Request to Mobile Node. The MN responds through MIH_Net_HO_Candidate_Query Response which contains Mobile Node's acknowledgement about the handover and its preferred link and PoS lists.

3) Serving PoS sends MIH_N2N_HO_Query_Resources Request to one or more Candidate PoSs to check the availability of the resource at candidate networks. Candidate PoS responds by sending MIH_N2N_HO_Query_Resources Response to Serving PoS.

4) Serving PoS decides the target of the handover based on the available resource status at candidate networks.

5) Serving PoS sends MIH_N2N_HO_Commit Request to Target PoS to prepare resource at the target network. Target PoS responds the result of the resource preparation by sending MIH_N2N_HO_Commit Response.

6) After identifying that resource is successfully prepared, Serving PoS commands Mobile Node to commit handover toward the specified network type and PoA through MIH_Net_HO_Commit Request.

### Example 1

### Financial Value Trading

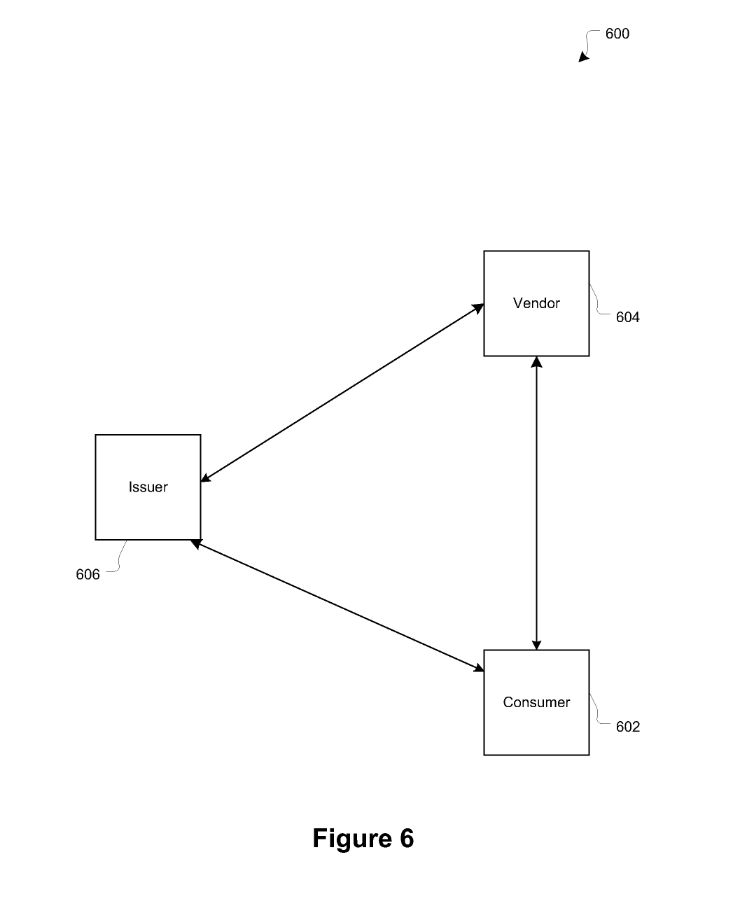

FIG. 6 shows the cooperation of exemplary market participants of an illustrative implementation of a digital credit or currency transaction platform 600.

As is shown in FIG. 6, in an exemplary operation using the logic devices and systems described above with respect to FIGS. 1-5, the consumer 602 makes a transaction with a vendor 604 using a kind of media wallet which can be an account that is formed with zero contextual information attached thereto about its owner, thereby facilitating complete anonymity until and unless the owner discloses personal information about their user and by affiliating its account with other user accounts. A media wallet can be any of the MIH capable MN described above. The vendor 604 receives digital credits simultaneously or essentially simultaneously with the transaction time from the issuer 606 for the purchase. Optionally, the issuer 606 can charge the vendor 604 a fee, such as by retaining a fixed service charge (or a percentage of the value of the transaction). Alternatively, the issuer 606 can charge the consumer a fee (or a percentage of the value of the transaction). The consumer's currency account is adjusted for the amount of the purchase, simultaneously with the crediting of the Vendor's account.

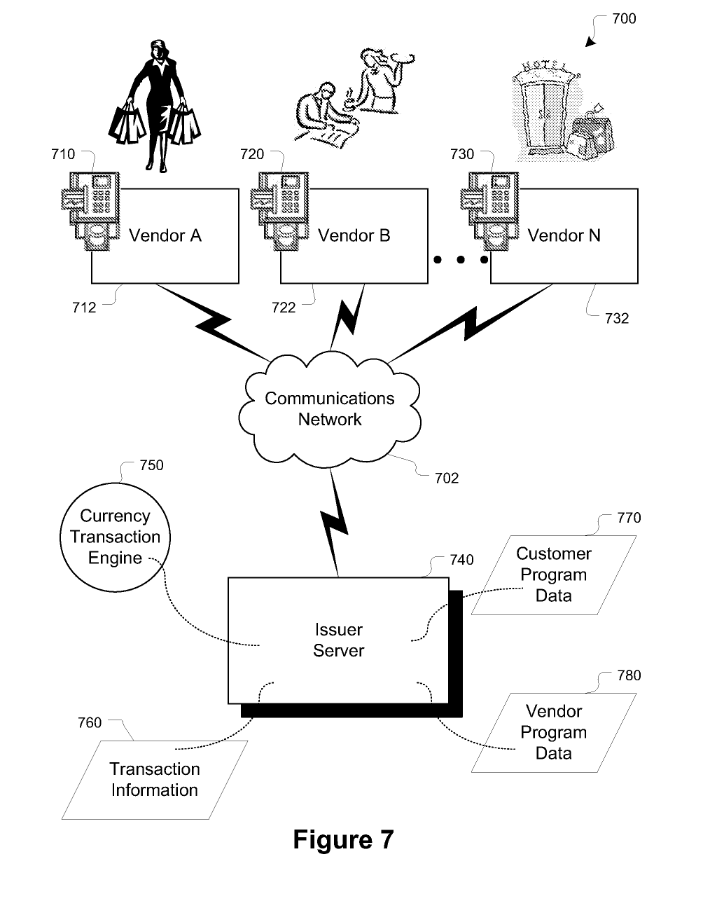

FIG. 7 shows an illustrative implementation, using the logic devices and systems described above with respect to FIGS. 1-5, of exemplary currency transaction platform 700, such as would be used for retail transactions using a media wallet platform as described herein. As is shown in FIG. 7, exemplary currency transaction platform 700 comprises one or more vendors, such as Vendor A 710, Vendor B 720 up to and including Vendor N 730, communications network 732, issuer server computing environment 740, currency transaction engine 750, data storage containing transaction data 760, and data storage containing customer program data 770 and vendor program data 780. Also, as is shown in FIG. 7, currency transaction platform comprises, for example, card readers 712, 722, and 732, shown reading consumer currency communication device, associated with Vendors 710, 720, and 730, respectively. Communications network 732 can comprise one or more of fixed-wire and/or wireless intranets, extranets, and/or the Internet.

In an illustrative operation, a consumer uses currency communication device with a reader associated with a vendor when making a purchase, to identify the account that will be debited for the purchase. The vendor then uses a vendor communication device to enter the amount of the purchase (not shown). A transmitter operatively associated with the vendor communication device (e.g., the card reader, cash register or keypad (not shown)), communicates the consumer identifying information and amount of the purchase to server computing environment 740 over communications network 732. In the illustrative operation, currency transaction engine 750 can operate on issuer server 740 to provide one or more instructions to issuer server 740 to debit a consumer currency account, to keep an accounting of the currency used by the consumer for purchases. The consumer's debit account information and transaction data (collectively “transaction information”) can be stored in transaction information storage 760. In addition, currency transaction engine 750 can operate on server computing environment 740 to provide processing in support of one or more customer programs using customer program data stored in customer program data storage 770. Such programs can include, for example, marketing programs directed to consumers. Optionally, vendor programs, such as marketing programs, can also be provided for participating vendors using Vendor program data 780.

In illustrative implementations, exemplary programs can include discounts, points, or special offers for additional products and/or services, such as offers directed to the consumer by the issuer, the vendor, and/or an affiliate, or the like.

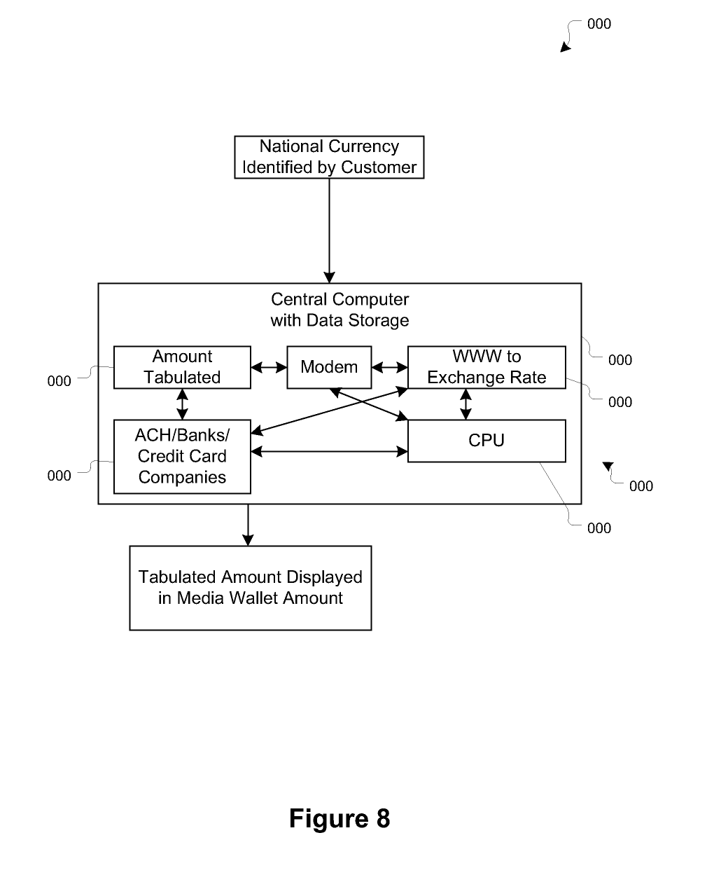

With reference to FIG. 8, according to some embodiments, a currency mechanism can include features as set forth below. In this regard, FIG. 8 shows an illustrative currency function (e.g., which can be implemented as a software module or via other means using the logic devices and systems described above with respect to FIGS. 1-5) for converting currency values from, e.g., a local currency to, e.g., multiple currencies for an Information Server Database to a digital currency value.

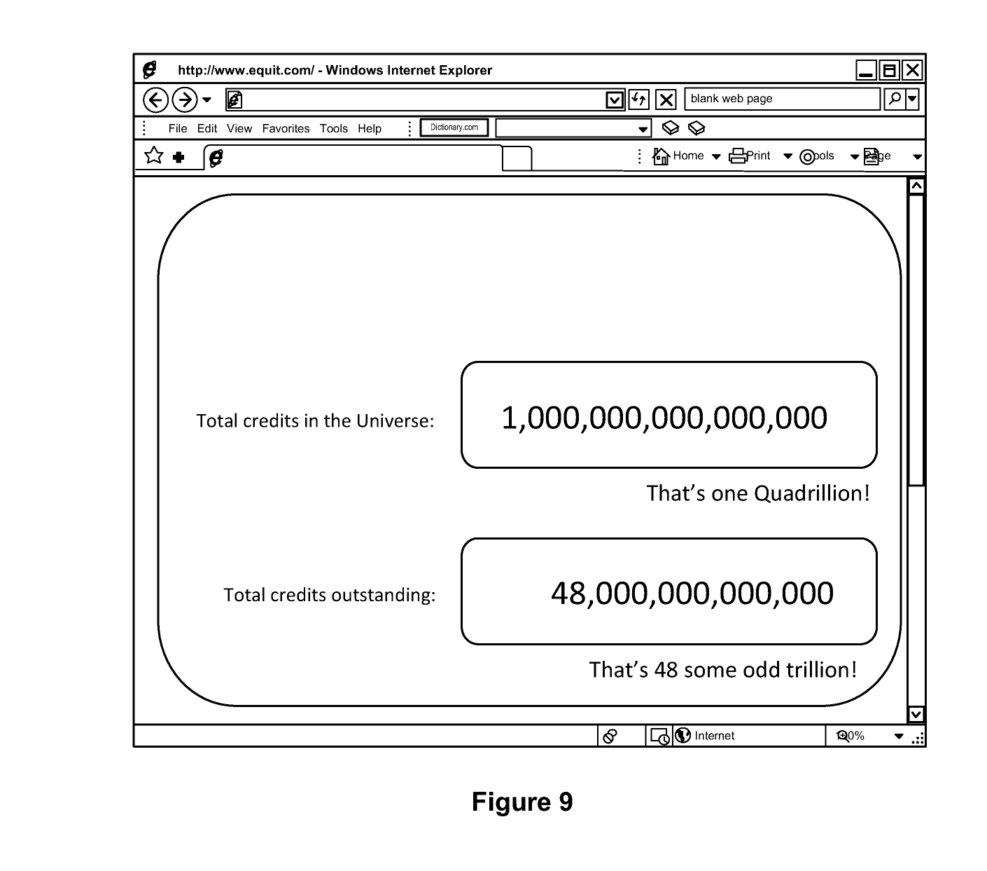

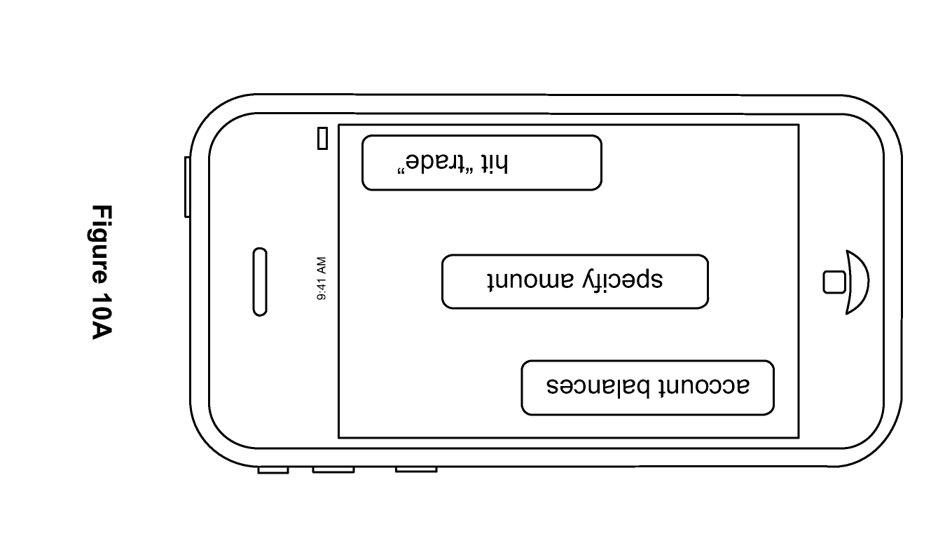

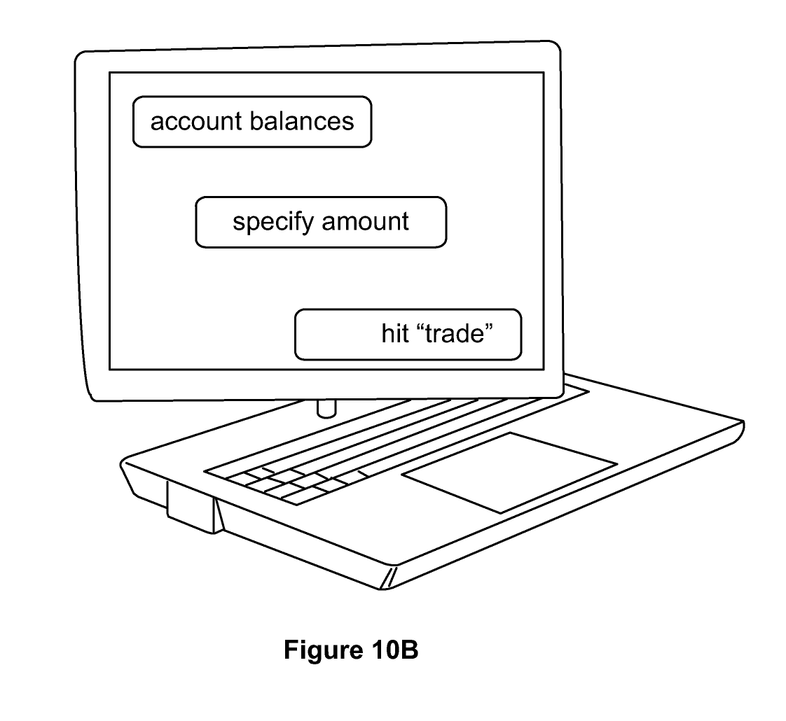

For example, the Mobile Node can make a simple query with specifying its desired currency (e.g., COST <1000 digital credits) (e.g., this could be its digital currency, but can also be the local currency). The Information Server then converts the simple query into the target currency. FIG. 9 illustrates a mock-up of a web page illustrating currency as a flat digital currency and FIG. 10A illustrates a handheld device having a display screen which displays currency as a flat digital currency; FIG. 10B illustrates a laptop computer having a display screen which displays currency as a flat digital currency.

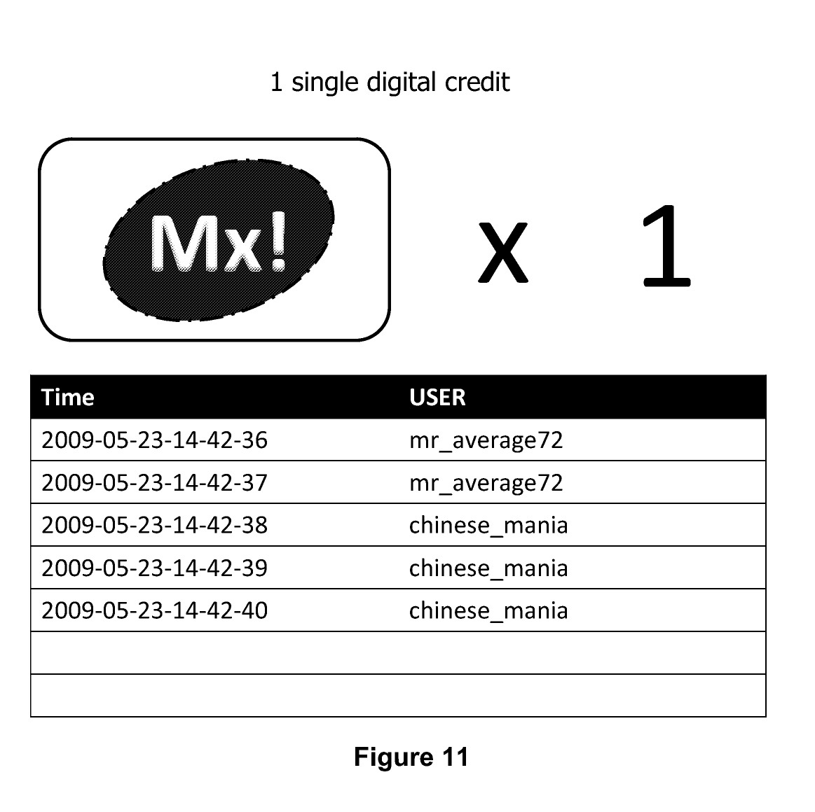

FIG. 11 illustrates a table with time and date stamp and user ID for currency as described above. Users are free to choose between making their currency holdings anonymous, or not. When digital fiat owner switches from non-anonymous user to anonymous, the currency management system will record “USER/anonymous, 13:23:11, Sunday, May 3, 2009”. When currency ownership transfers back to a non-anonymous owner,” USER/mr_average72, 13:23:11, Sunday, May 3, 2009.” The system enables determining at least the flow of currency in real time, which increases the efficiency and cost of capital analyses. Thus the computer, or electronic device, acts as an iterative point of production, or media wallet, for “producing” an electronic information-management tool that performs and records near immediate price discovery and transactional services on behalf of all market participants within the information management tool.

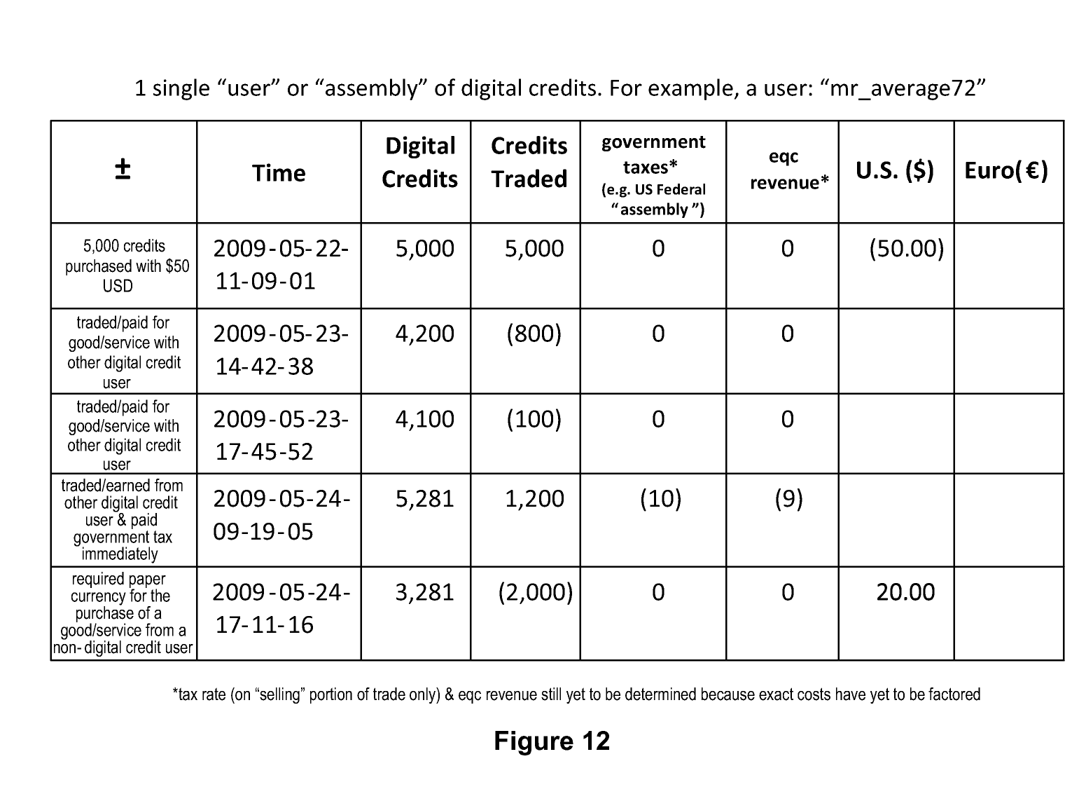

FIG. 12 illustrates a table which indicates a series of transactions for a single user stored in a table as part of software using the logic devices and systems described above with respect to FIGS. 1-5. The table provides a transaction history or balance statement for a user.

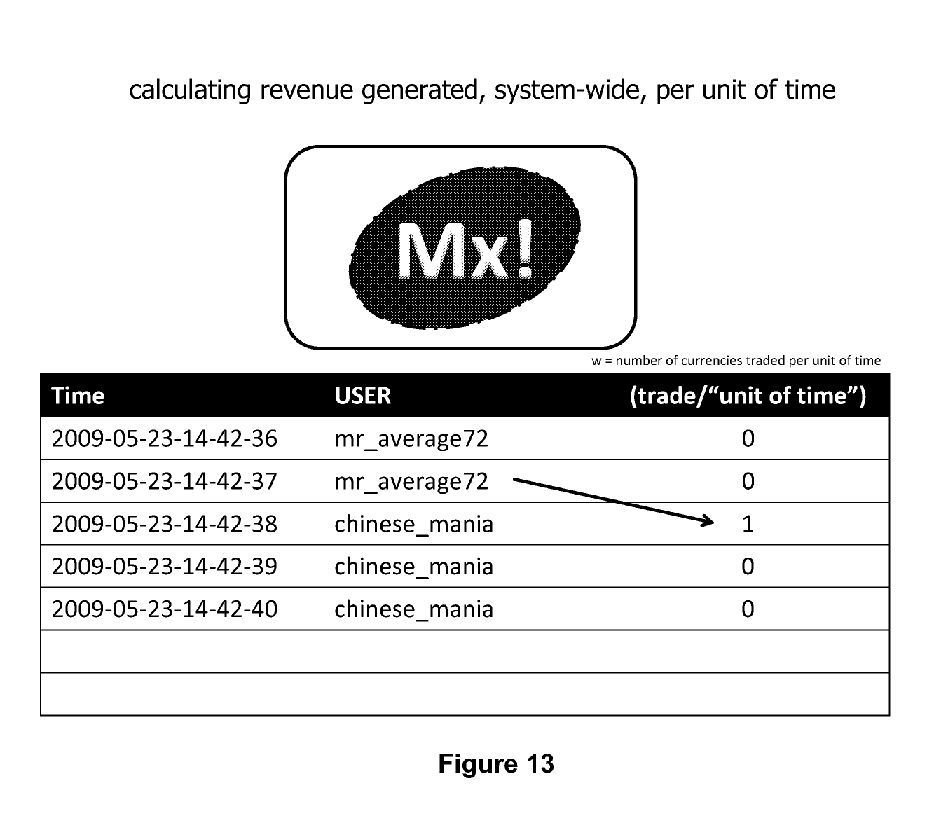

Turning to FIG. 13 illustrates a table configured to calculate revenue generated system wide using the logic devices and systems described above with respect to FIGS. 1-5, per unit of time.

### Example 2

### Two-Variable Digital Credit System

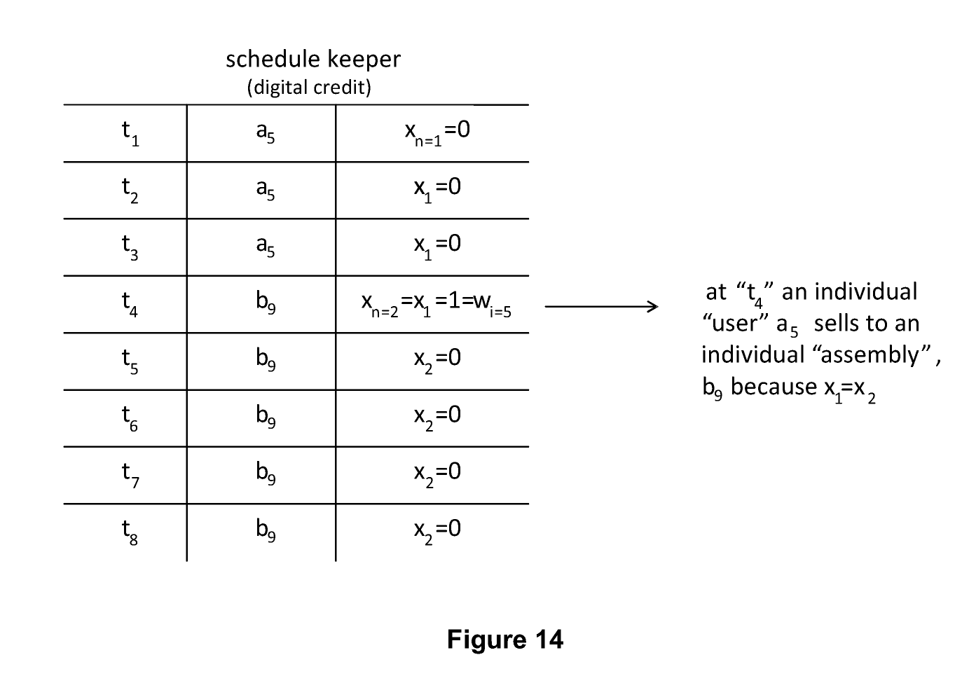

FIG. 14 shows a micro level and transition using a single schedule keeper and digital credits. The first variable, tₖ=t=unit of time which is a number or scalar (e.g., a second recorded in May 2009) and the second variable is the buyer or seller and system participants. u=total number of system participants receiving values at any particular time.
u=a+b
a=users
b=assemblies
aᵢ or bᵢ (for i ε [1,u])=system participant recorded by any schedule-keeping record (digital credit) at any particular time
   The individual, bivariate, recording functions a the micro level (1 seller_{[n=1]} vs. 1 buyer_{[n=2]} are: (xₙ)ₜ=value (a number, or scalar) assessed by traders in a market (seller/buyer), i.e. before trade is conducted (theoretical with respect to human participants). Transitioning from micro to macro for a specific time t, such that (x₁)ₜ−(x₂)ₜ=0, the “quantified difference” between how any two system-participants should reconcile value at any particular time, or: (x₁)ₜ=(x₂)_{t.}

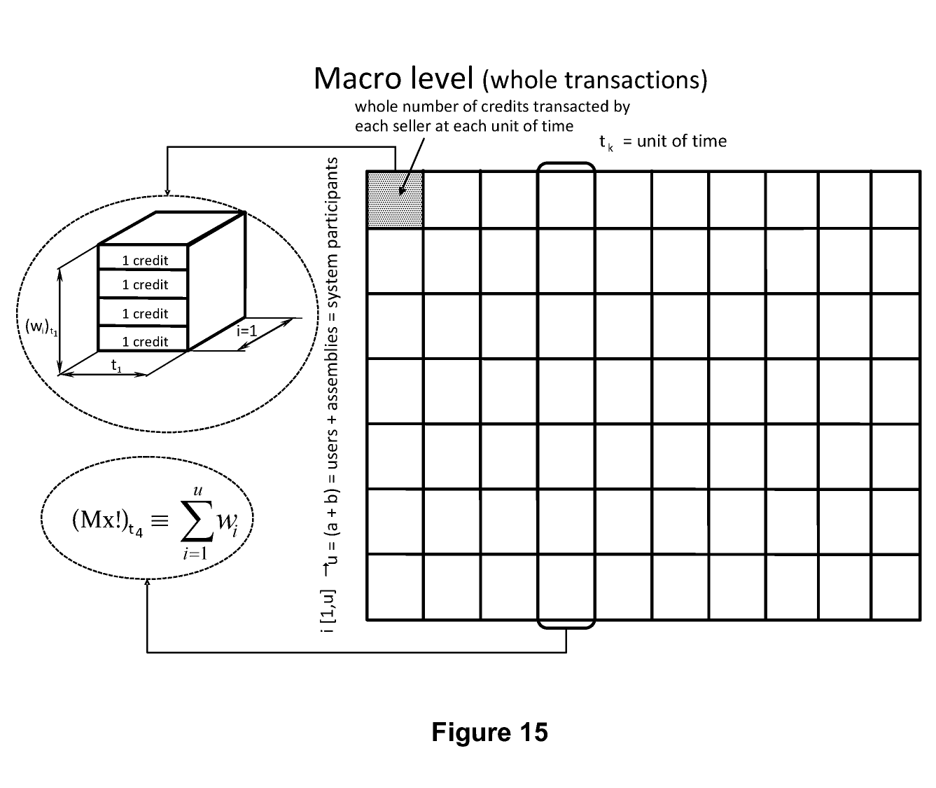

Turning to FIG. 15, a macro level is illustrated with each participant[i] in the economy. The system is illustrated containing only seven transactions consisting of digital credits/currency.

$${( M x ! )}_{t 4} ≡ {\sum }_{i = 1}^{u} {w}_{i}$$

Where Mx!ₜ₄=Mx!=the sum total of the speed of revenue following throughout the computer implemented system at t₄.

### Example 3

### Four-Variable Schedule Keeping System

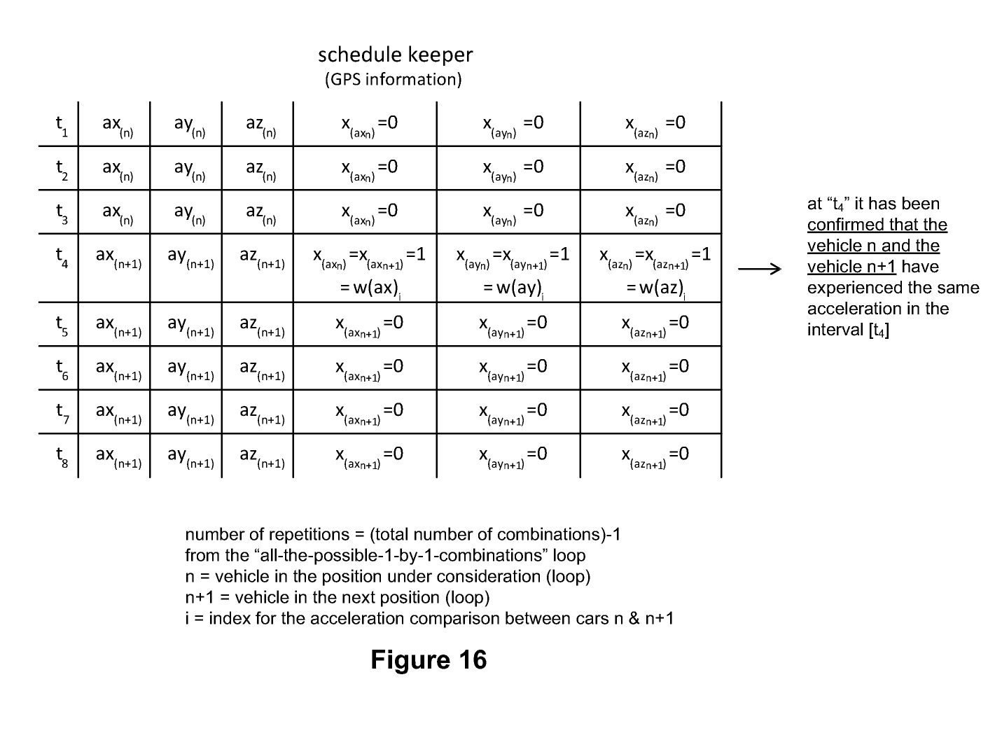

FIG. 16 shows a micro level and transition using a single schedule keeper and unitary GPS readings. At t4 it can be confirmed that the vehicle n and the vehicle n+1 have experienced the same acceleration in the interval [t4], With some system correction, e.g., equilacceleration provoked by the system, or without it (e.g., equilacceleration resulting from the normal traffic evolution). A four variable system can have, for example, the following variables:
1st variable:
t=unit of time which is a number, or scalar (e.g. a second recorded in May 2009)
2nd variable:
(pre-/post-feedback) acceleration of the vehicle in the x-direction=value (a number, or scalar) received by any schedule-keeping record at any particular time
3rd variable:
(pre-/post-feedback) acceleration of the vehicle in the y-direction=value (a number, or scalar) received by any schedule-keeping record at any particular time
4th variable:
(pre-/post-feedback) acceleration of the vehicle in the z-direction=value (a number, or scalar) received by any schedule-keeping record at any particular time
u=total number of system-participants receiving values at any particular time (vehicles)

In this example, the following apply:
number of repetitions=(total number of combinations)−1 from the “all-the-possible-1-by-1-combinations” loop
n=vehicle in the position under consideration (loop)
n+1=vehicle in the next position (loop)
i=index for the acceleration comparison between cars n & n+1
when x₍ₐₓ_{ₙ}₎=x₍ₐ_{ₙ₊₁}₎, _{(ay}_{ₙ}₎=x_{(ay}_{ₙ₊₁}₎
and x_{(az}_{ₙ}₎=x_{(az}_{ₙ₊₁}₎ will indicate
a “1”, while all other static events per unit of time will yield a “0” to reflect the absence of “acceleration cross-checking”.
   At the micro level, vehicle_{[n]} vs. 1 vehicle_{[n+1]}, where (axₙ)ₜ [, (ayₙ)ₜ or (azₙ)ₜ]=acceleration in the x(y or z)-direction value (a number, or scalar) assessed by each vehicle, e.g. before the system feedback comes into picture and confirms or corrects it. n ∀ local position of each vehicle within the list specifically created in order to perform the required detailed combinatorics (each vehicle has to be compared against all the other ones in the system under consideration).

Transitioning from micro to macro for a specific time t, such that (axn)t−(axn+1)t=0 (AND (ayn)t−(ayn+1)t=0 AND (azn)t−(azn+1)t=0), the “quantified difference” between how any two system-participants SHOULD reconcile value at any particular time, or: (axn)t=(axn+1)t AND (ayn)t=(ayn+1)t AND (azn)t=(azn+1)t. For the macro level (each “equilaccelerated” vehicle[i] within the whole system) (w(ax)i)t [, (w(ay)i)t or (w(az)i,n)t]=acceleration of each vehicle n in the x(, y or z)-direction after the system feedback (after comparing it against the one from the car n+1) has occurred=confirmed to be equilaccelerated/corrected to become equilaccelerated.

### Example 4

### Reduction in Tax Revenue Loss

Following the same transactional, digital currency systems and processes described above with respect to Example 1, the system can be further configured to reduce tax revenue loss by enabling the system to simultaneously transfer currency from a transaction to a tax authority as part of the transaction. Thus; when a consumer makes a purchase using digital credits, for example, a portion of the transaction covering, for example, the price of the goods or services, is transferred to the vendor, while a portion of the transaction cover the local and/or regional tax is transferred directly to the local and/or regional taxing authority. The real time transfer of tax revenue for transactions to the relevant tax authorities will result in a reduction of tax revenue loss; thereby enabling, for example, government's access to significantly higher amounts of working capital to pay for public goods as opposed to debt.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer readable medium having computer readable instructions adapted and configured to instruct a computer to perform a method comprising:
receiving values from any information transmission device;
recording a near-immediate transition of any number of values between any number of system elements, using a float of electronically produced schedule keepers of value quantifying a change in any variables with respect to users in an application; and
at least one of correcting and transmitting information to assist with delivering useful information to achieve a desired outcome.

2. The computer readable medium of claim 1 wherein the variable is currency.

3. The computer readable medium of claim 1 wherein the application is a financial application.

4. The computer readable medium of claim 1 wherein the values are selected from the group consisting of single or multivariable.

5. The computer readable medium of claim 1 wherein the system elements are identified by contextual information disclosed by a user.

6. The computer readable medium of claim 1, the method further comprising the step of: reducing a payment to a vendor by an amount of one or more of a fee for a transaction and a tax.

7. The computer readable medium of claim 6, the method further comprising: deducting an additional fee by an amount of one or more of a fee for a transaction and a tax.

8. A system adapted and configured for producers and consumers to conduct transactions on a computer implemented system using a digital currency comprising:
a smart electronic digital currency device adapted and configured to maintain owner identifiable information across time;
a communicator adapted and configured to enable a buyer and seller within a system to access one or more of business and financial information;
an input device adapted and configured for inputting an amount of a digital currency transaction;
a transmitter adapted and configured for sending digital currency transaction information pertaining to a trade via a common application that includes market participant information and a transaction amount in a digital currency;
a communications network adapted and configured for conveying the digital currency transaction information; and
a server arranged with a receiver and adapted and configured for receiving the digital currency transaction information and for maintaining current digital currency account information on behalf of all system participants.

9. The system of claim 8, wherein the server is arranged to reduce a payment to a seller by an amount of a market-making service fee.

10. The system of claim 8, further comprising: a digital currency transaction engine for keeping an accounting of a digital currency balance owed to any system participant.

11. The system of claim 8, further comprising: a transaction information storage device adapted and configured for storing consumer digital currency credit account information and transaction information.

12. The system of claim 8, further comprising: a customer program data storage device for storing customer program data for use in one or more customer programs directed to at least one of the system or market participants.

13. The system of claim 8, wherein the communications network comprises at least one of a wired network and a wireless network.

14. A method for a consumer to make transactions in a digital currency at a predetermined exchange rate, comprising:
enabling a consumer to prepay an issuer for a selected quantity of a digital currency at a exchange rate determined by the issuer;
issuing to the consumer a digital currency that identifies the consumer and indicates an amount of the digital currency owed by the issuer to the consumer for use in digital currency transactions made using the digital currency;
enabling the consumer to conduct at least one transaction with a seller in an amount of the digital currency not to exceed the selected amount;
paying a digital currency in the amount of the transaction to the seller; and
reducing a quantity of the digital currency owed to the consumer by the amount of the transaction.

15. The method of claim 14 wherein the step of issuing is performed anonymously.

16. The method of claim 14, wherein the digital currency transaction is a purchase or a cash withdrawal.

17. The method of claim 14, further comprising charging the sellers a transaction fee for enabling a more efficient transaction.

18. The method of claim 14, further comprising: calculating the digital currency exchange rate based on a spot exchange rate at the time of the consumer pre-paying the issuer.

19. The method of claim 14, wherein information pertaining to the quantity of digital currency owed to the consumer is stored within the digital currency account.

20. The method of claim 14, wherein information pertaining to the quantity of digital currency owed to the consumer is stored on a server.
